(19) United States
(12) Patent Application Publication
(10) Pub. No.: US 2004/0250690 A1
(43) Pub. Date: Dec. 16, 2004

(54) Cooking vessel and lid therefor

(76) Inventors: Thomas Restis, Buffalo Grove, IL (US); Paul Erhardt, Naples, FL (US); Yvonne Lin, Brooklyn, NY (US); Patrick Kerulis, Carol Stream, IL (US); Maximillian Philip Burton, New York, NY (US); Steven Vordenburg, New York, NY (US)

Correspondence Address: Harold V. Stotland, Seyfarth Shaw LLP, Suite 4200, 55 East Monroe Street, Chicago, IL, 60603-5803, US

(21) Appl. No.: 10/754,309

(22) Filed: Jan. 9, 2004

Related U.S. Application Data
(60) Provisional application No. 60/438,835, filed on Jan. 9, 2003.

(51) Int. Cl. A47J 37/12

(52) U.S. Cl. 99/403

(57) ABSTRACT

A cookware assembly includes an open-top vessel with diametrically opposed handles and diametrically opposed pour spouts, and a lid including an outer peripheral frame member, a central member spaced from the frame member and support structure coupled to each of the frame member and the central member closing the space therebetween. A flange depends from the frame member and has a plurality of vertically elongated apertures therethrough adjacent to a predetermined location on the frame which carries indicia to indicate the location of the apertures.

### RELATED APPLICATION

This application claims the benefit of the filing date of copending U.S. Provisional Application No. 60/438,835, filed Jan. 9, 2003.

### BACKGROUND

This application relates to cookware, such as cooking vessels or containers. The application relates specifically to lidded cooking vessels, the lids therefore and the cooperation between the vessel and its lid.

Various types of lidded cooking vessels or containers have heretofore been provided, including a variety of different types of pots and pans. It is also known to provide lidded cooking vessels with pour spouts which are substantially blocked in one position of the lid and unblocked in another position of the lid to facilitate pouring without removing the lid. However, it is often difficult to determine which position the lid is in relative to the spout and, furthermore, it is often difficult to pour contents from the vessel while the lid is in place without dislodging the lid, particularly in the case of large-capacity vessels, which may be rather heavy when filled, and which may be quite hot where pouring is to be effected immediately after cooking.

It is also known to provide cooking vessel lids which are formed substantially of a light-transmitting material, such as glass, the lid being provided with a metal rim for engagement with the vessel. The glass covers substantially the entire width of the vessel opening and this large expanse of glass substantially increases the weight of the lid and the risk of cracking or breakage.

### SUMMARY

There is disclosed in this application an improved assembly of a cooking container or vessel and associated lid which avoids the disadvantages of prior assemblies while affording additional structural and operating advantages.

An aspect is the provision of an improved lid of multi-part construction.

A further aspect of the disclosed assembly is that it provides ready indication of the position of straining apertures in the lid relative to a pour spout on the vessel.

Another aspect is the provision of an assembly of the type set forth, which facilitates holding the lid in place on the vessel while pouring.

In an embodiment, there is provided a cookware lid comprising an outer peripheral frame defining a central opening, a central member discrete from the frame and disposed in the central opening, and support structure connected to each of the frame and the central member for cooperation therewith to seal the central opening.

There is also provided, in an embodiment, a cookware lid comprising a main body, a flange depending from the main body, the flange having a plurality of vertically elongated apertures therethrough grouped adjacent to a predetermined location on the main body, and indicia on the main body at the predetermined location to indicate the location of the apertures.

There is further provided, in an embodiment, a cookware lid comprising a main body having a peripheral rim, and pads formed of thermally insulating material disposed on the main body adjacent to the peripheral rim.

An embodiment also provides cookware comprising an open-top vessel having an upstanding peripheral wall terminating at an upper edge, and a pour spout formed on the peripheral wall adjacent to the upper edge; and a lid having a main body, a flange depending from the main body, the flange having a plurality of vertically elongated straining apertures therethrough grouped adjacent to a predetermined location on the main body, and indicia on the main body at the predetermined location for indicating the location of the apertures, the lid being disposable on the upper edge of the vessel in a covering condition for closing the open top thereof with the flange disposed within the upper edge of the peripheral wall, the lid while in the covering condition being disposable in a first orientation with the apertures out of alignment with the pour spout and a second orientation with the apertures aligned with the pour spout.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side elevational view of an assembly of a cooking vessel and a lid, with the lid in place in a venting orientation;

FIG. 2 is a top plan view of the assembly of FIG. 1;

FIG. 3 is a view similar to FIG. 1, with the lid removed;

FIG. 4 is an enlarged, fragmentary sectional view of a portion of the lid of FIG. 2 taken generally along line 4-4 therein;

FIG. 5 is a sectional view of the lid of FIG. 2 taken generally along the line 5-5 therein;

FIG. 6 is an enlarged, fragmentary, sectional view of a portion of the lid of FIG. 4 taken generally along the line 6-6-therein;

FIG. 7 is a sectional view of the lid of FIG. 2 taken generally along the line 7-7 therein;

FIG. 8 is an enlarged, fragmentary, sectional view of the circled portion of the lid of FIG. 7;

FIG. 9 is a view similar to FIG. 7, but with the lid rotated 90° to a blocking orientation;

FIG. 10 is a top plan view of the assembly of FIG. 9;

FIG. 11 is a view similar to FIG. 1, illustrating pouring from the vessel;

FIG. 12 is a top plan view of the assembly of FIG. 11;

FIG. 13 is a top plan view of another embodiment of a lid;

FIG. 14 is a side elevational view of the lid of FIG. 13;

FIG. 15 is a sectional view taken generally along the line 15-15 in FIG. 13; and

FIG. 16 is an enlarged, fragmentary view of the circled portion of FIG. 15.

### DETAILED DESCRIPTION

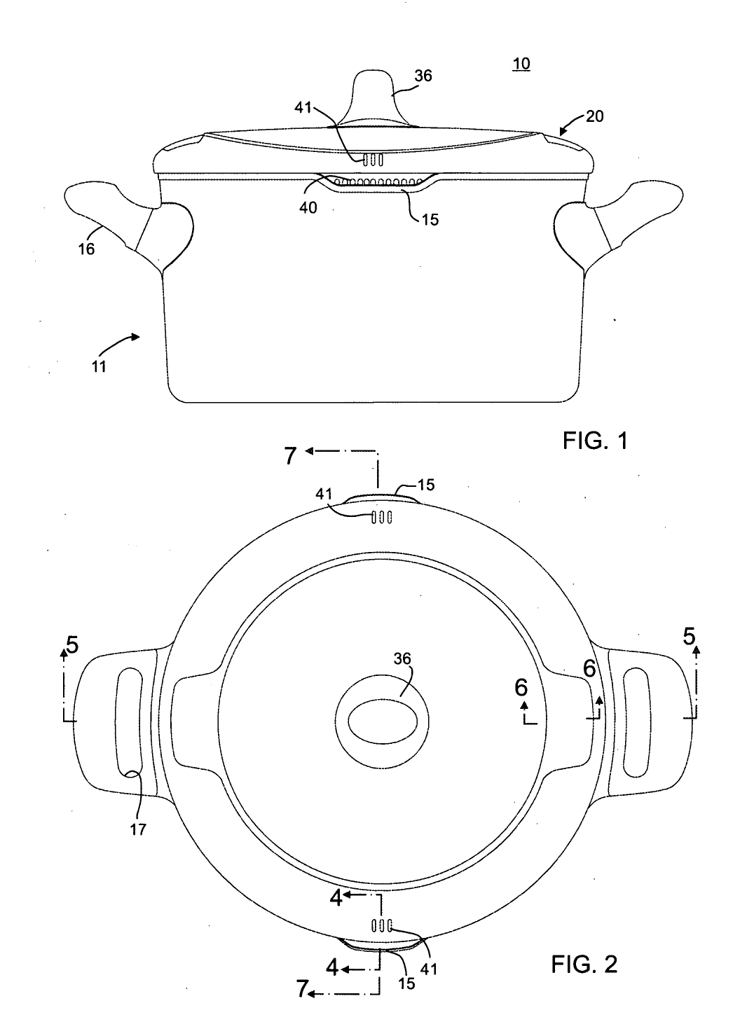

Referring to FIG. 1, there is illustrated a cooking assembly, generally designated by the numeral 10, including a container or vessel 11 and a lid 20. The container 11 is in the nature of a stock pot or the like, but it will be appreciated that it could have any of a number of different sizes and shapes. The container 11 includes a substantially circular bottom wall 12, integral around its periphery with an upstanding peripheral side wall 13 terminating in an upper edge 14. Formed in the upper edge 14, at diametrically opposed locations, are two laterally outwardly projecting pour spouts 15. Integral with the side wall 13 and projecting laterally outwardly therefrom at diametrically opposed locations spaced substantially 90° from the spout locations are two handles 16, each having a slot 17 formed therein. It will be appreciated that the container 11 could be formed of any of a number of different materials, preferably various metals. If desired, each handle 16 may have a core formed of a suitable material, such as a phenolic, and be provided with a thermal insulating covering formed of a suitable material, such as a silicone, and adapted to be grasped by a user's fingers.

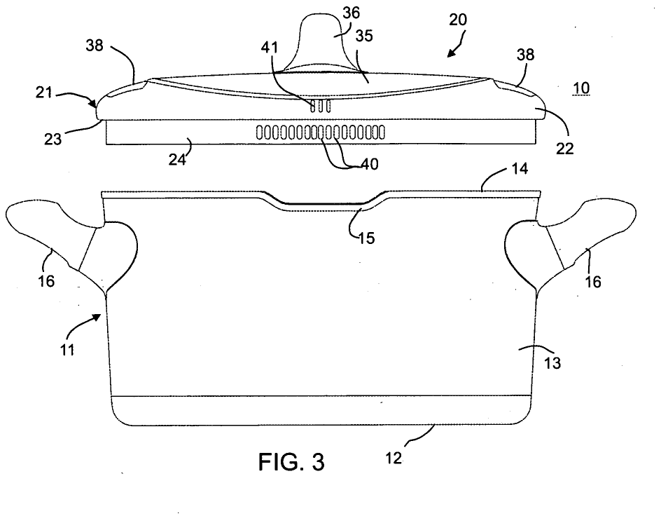

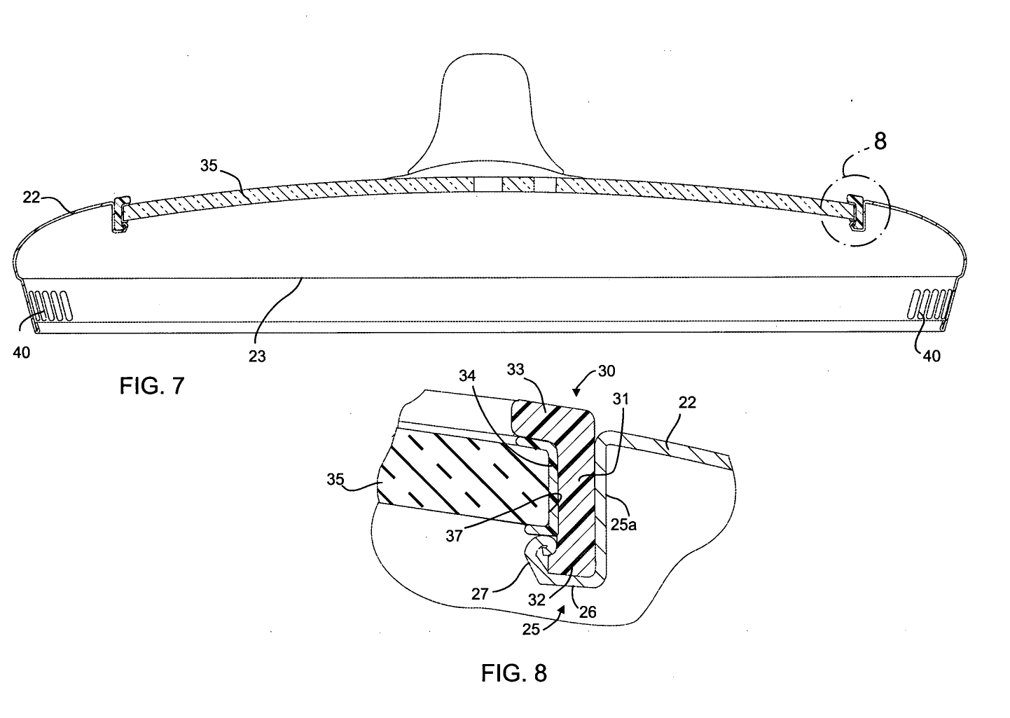

Referring also to FIGS. 2-8, the lid 20 has an annular frame 21 with a convex top wall 22 curved under around its periphery to define an annular shoulder 23 (FIG. 3), from which depends a substantially cylindrical outer skirt or flange 24. The inner edge of the top wall 22 is bent downwardly to define a support portion 25 including a substantially cylindrical depending inner flange 25a, integral at its lower edge with a laterally inwardly extending annular flange 26, which is in turn integral at its inner edge with an upturned lip 27. At two diametrically opposed locations on the frame 21, the flanges 25 and 26 extend laterally outwardly to define a pair of enlarged recesses 28 (see FIGS. 2 and 6).

The support portion 25 defines a circular central opening and forms part of a support structure which also includes an annular ring 30, which may be formed of a suitable thermally insulating plastic material, such as a suitable polyester. The ring 30 is generally channel-shaped in transverse cross section, having a cylindrical body 31 integral at its lower end with a laterally inwardly extending annular toe 32 and at its upper end with a laterally inwardly extending flange 33 (see FIG. 8). The ring 30 is dimensioned to be seated against the flanges 25 and 26, so that the toe 32 fits up beneath the lip 27, as can be seen in FIG. 8. The support structure also includes an annular gasket 34 which lines the inner surfaces of the ring 30, the gasket 34 being formed of a suitable elastomeric material, such as silicone. The gasket 34 grips the peripheral edge 37 of a generally circular central member in the form of a glass top 35, which is spaced from the frame 21 by the ring 30 and the gasket 34 and cooperates with those parts to close the central opening defined by the annular frame 21. The top 35 may be provided with an upstanding, centrally located knob 36. The ring 30 may be integral with enlarged, laterally outwardly extending thumb pads 38, which may respectively fill the recesses 28 (see FIG. 6) and may be formed of a suitable thermally insulating material. It will be appreciated that the thumb pads 38 could be formed unitarily with the ring 30 or, alternatively, could be formed separately therefrom.

It can be seen that the glass top 35, the annular ring 30, the gasket 34 and the top wall 22 and shoulder 23 of the frame 21 cooperate to form a main body of the lid 20, from which the skirt or flange 24 depends.

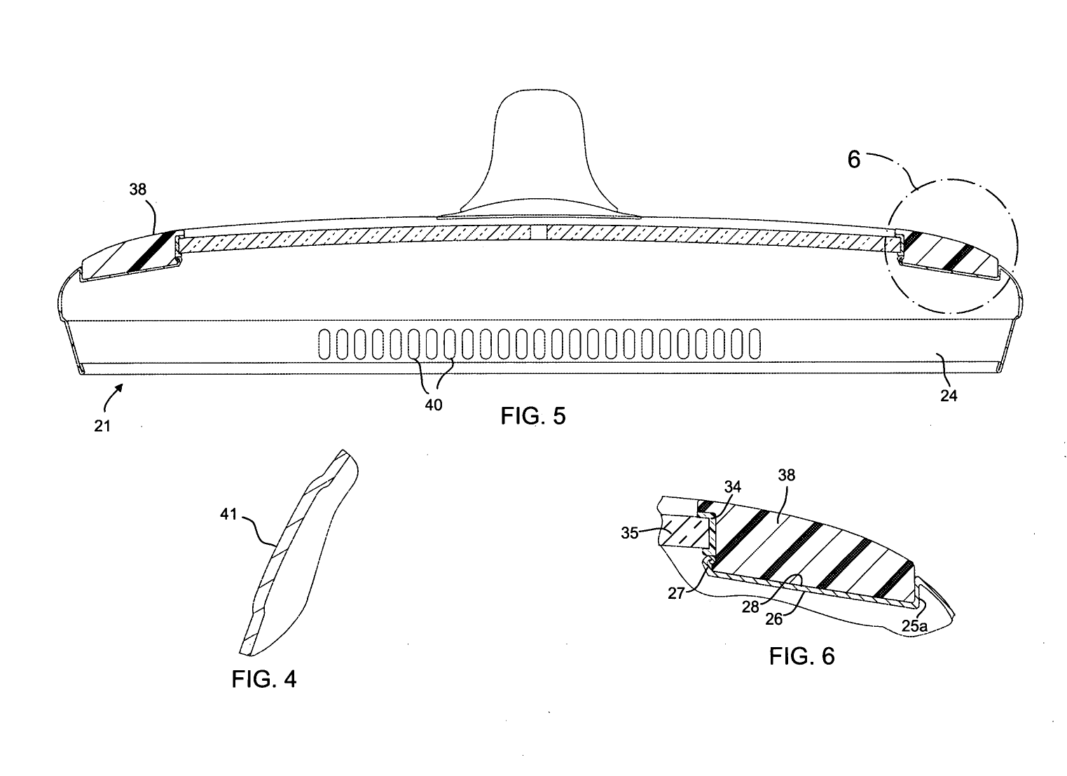

Formed through the skirt 24 at diametrically opposed locations thereon, respectively spaced approximately 90° from the recesses 28, are two rows of apertures 40 (see FIGS. 3, 5 and 7), each of which apertures is generally oval or oblong in shape with its long axis oriented vertically. Formed on the top wall 22 of the annular frame 21 at locations respectively centered along the rows of apertures 40 are marker indicia 41, which may comprise a group, such as three, of markings shaped generally like the apertures 40 to provide an indication of the location of the rows of apertures 40 in use. The indicia 41 may be formed by stamping the top wall 22 of the annular frame from the underside thereof to form slightly raised indicia (see FIG. 4).

It will be appreciated that the lid 20 is dimensioned so that, in use, the skirt 24 will fit telescopically down inside the edge 14 of the container side wall 13, so that the edge 14 seats against the shoulder 23, all in a known manner.

Referring to FIGS. 1 and 2, the assembly 10 is illustrated in a vented cooking position, wherein the lid 20 is installed in place on the container 10 with the rows of apertures 40 respectively aligned with the spouts 15. In this orientation, steam or other vapors emanating from the cooked contents of the container 11 may escape through the apertures 40 and the spouts 15. It will be appreciated that the user can determine from above that the drain apertures 40 are properly aligned with the spouts 15 by aligning the marker indicia 41 with the spouts, as illustrated in the figures.

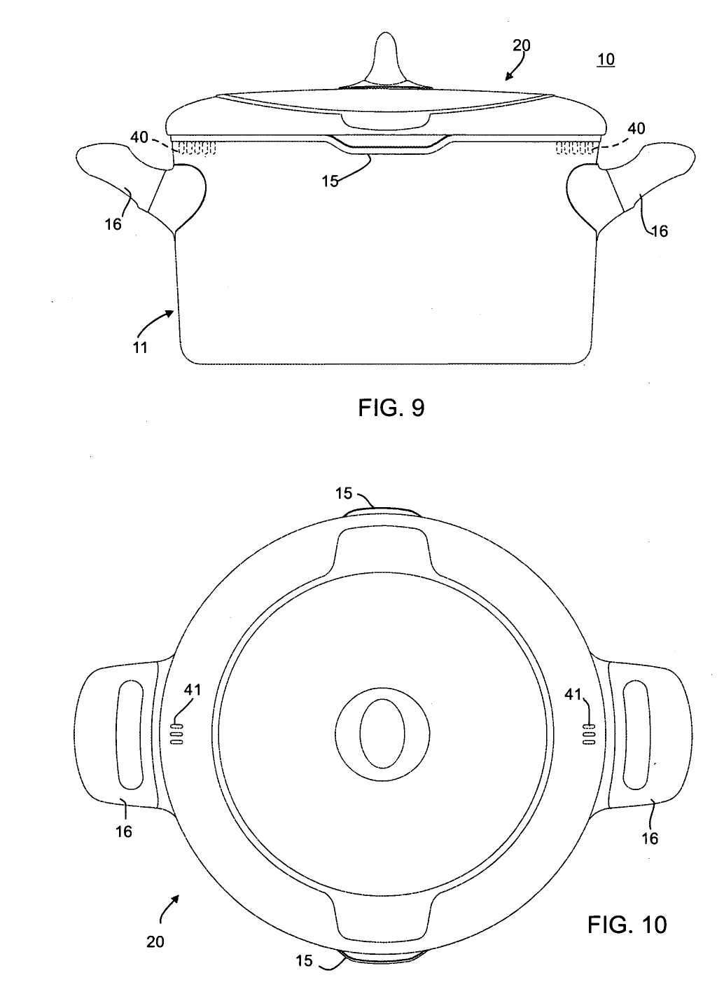

When it is desired to cook the contents of the container 11 without permitting venting of vapors therefrom, the lid 20 is installed in place in the orientation illustrated in FIGS. 9 and 10, with the apertures 40 out of alignment with the spouts 15. In the illustrated embodiment, the rows of apertures 40 are respectively aligned with the handles 16, as indicated by the positions of the marker indicia 41.

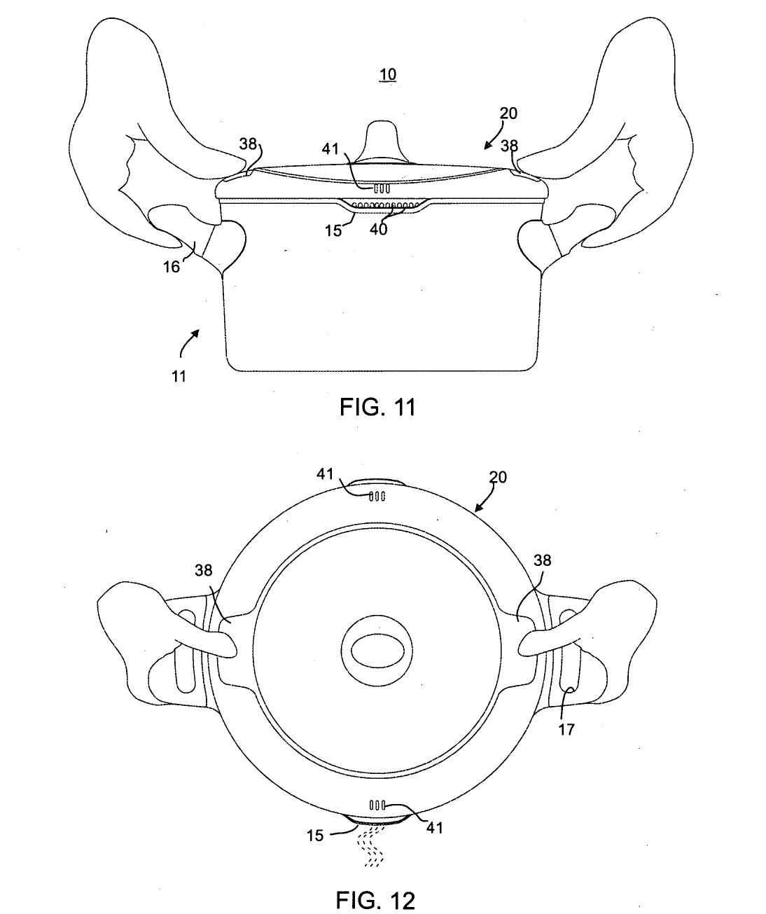

Referring to FIGS. 11 and 12, when it is desired to pour liquids from the container 11 with the lid 20 in place, the lid 20 is first rotated to the vent position of FIGS. 1 and 2 to align the apertures 40 with the spouts 15. Then, the user may lift the container 11 by grasping the handles 16 with the fingers of both hands, while pressing the thumbs against the thumb pads 38 to hold the lid 20 in place during the pouring operation. The thermally insulating nature of the handles 16 and the thumb pads 38 will protect the user's hands from burning. The apertures 40 are so sized in shape as to perform a straining function, permitting liquid contents to be poured from the vessel 11, while preventing the passage of most non-liquid contents through the apertures 40 and the spout 15.

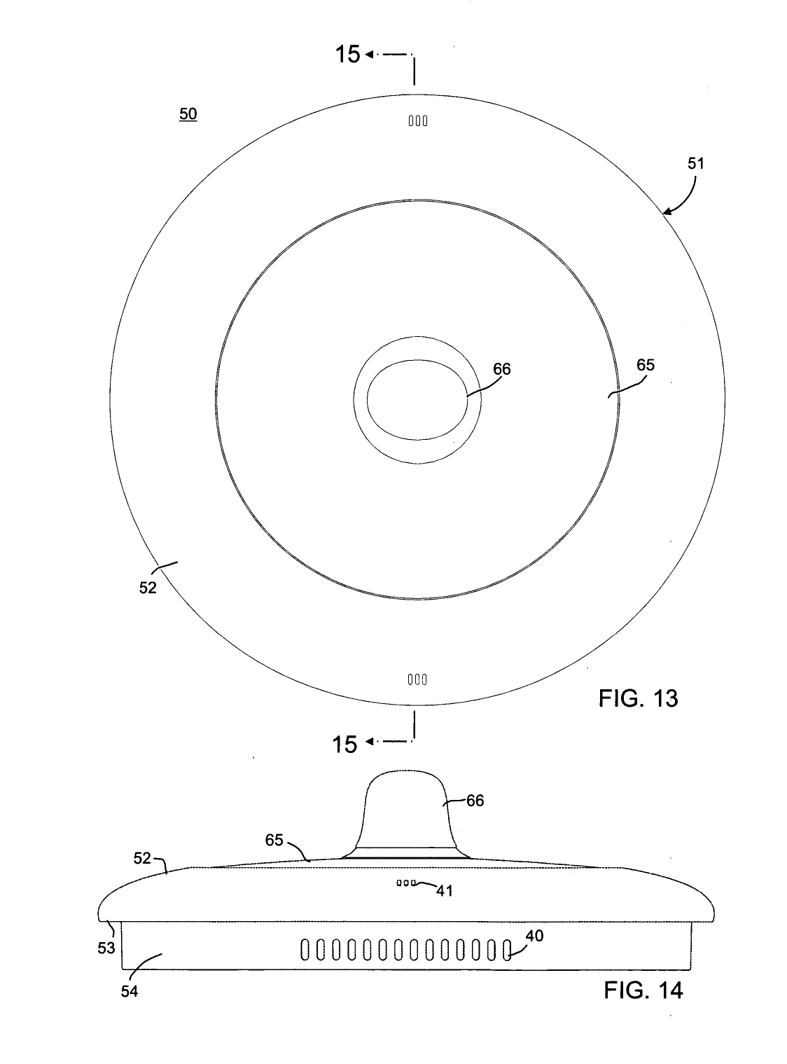

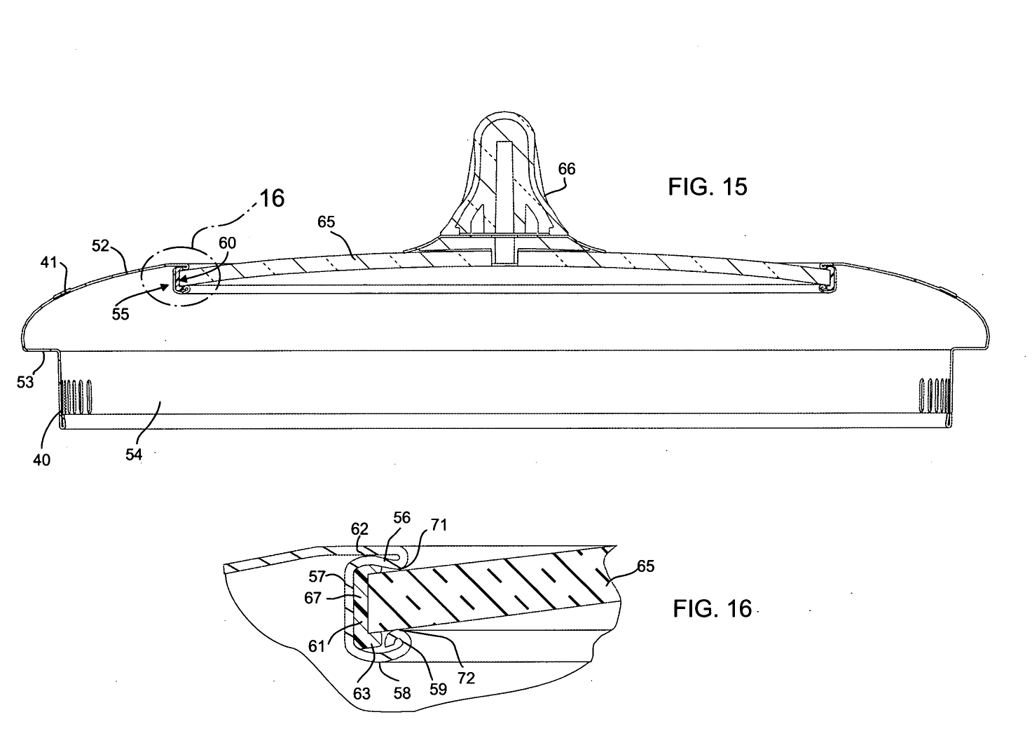

Referring to FIGS. 13-16, there is illustrated an alternate lid, generally designated by the numeral 50. The lid 50 has an annular frame 51 with a convex top wall 52 curved under around its periphery to define an annular shoulder 53 (FIG. 14), from which depends a substantially cylindrical outer skirt or flange 54. The inner edge of the top wall 52 is bent downwardly to define an annular, depending support channel 55. More specifically, the inner edge of the top wall 52 is bent back on itself to define an upper leg 56 of the channel, and then bent downwardly to define a vertical leg 57 and then laterally inwardly to define a concave lower leg 58 which terminates in a curled back lip 59. The support channel 55 forms part of support structure which also includes an annular gasket 60 which is generally channel-shaped in transverse cross section and is disposed in the channel 55. More specifically, the gasket 60 has a vertically disposed, cylindrical body 61, integral at its upper end with a radially inwardly projecting upper flange 62 and in its lower end with a radially inwardly projecting lower flange 63.

The lid 50 also includes a circular central member in the form of a glass top 65 which may be provided with an upstanding, centrally located knob 66. The glass top 65 has a peripheral edge 67 which is received in the channel 55 and disposed in sealing engagement in the gasket 60. The upper leg 56 and the lip 59 of the channel 55 respectively define contact points 70 and 71 disposed in contact, respectively, with the upper and lower surfaces of the top 65 adjacent to its peripheral edge for firmly supporting the top 65.

The lid 50 is provided with two rows of apertures 40 and marker indicia 41 in the same manner as was described above with respect to the lid 20, and the lid 50 functions in essentially the same manner as the lid 20.

From the foregoing, it can be seen that there has been provided an improved cooking vessel assembly which includes a container and a lid which is provided with apertures and with indicia to indicate the position of the apertures relative to spouts on the container. Thumb pads may be provided on the lid to protect a user's thumbs from burning while pouring liquid contents from the container. The multi-part construction of the lid 20 permits a reduced-size glass top 35 to be mounted on the frame 21 while effectively sealing the main body of the lid. It will be appreciated that the top 35 may be formed of transparent or translucent glass, or could be formed of light-transmitting materials.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A cookware lid comprising:
an outer peripheral frame defining a central opening,
a central member discrete from the frame and disposed in the central opening, and
support structure connected to each of the frame and the central member for cooperation therewith to seal the central opening.

2. The lid of claim 1, wherein the outer peripheral frame is circular in shape.

3. The lid of claim 1, wherein the central member is formed of a light-transmitting material.

4. The lid of claim 3, wherein the central member is formed of transparent glass.

5. The lid of claim 1, wherein the support structure is annular in shape.

6. The lid of claim 5, wherein the support structure is channel-shaped in transverse cross section.

7. The lid of claim 1, wherein the support structure includes a support portion of the frame and a gasket sealing a peripheral edge of the central member.

8. A cookware lid comprising:
a main body,
a flange depending from the main body,
the flange having a plurality of vertically elongated apertures therethrough grouped adjacent to a predetermined location on the main body, and
indicia on the main body at the predetermined location to indicate the location of the apertures.

9. The lid of claim 8, wherein the plurality of apertures includes a horizontal row of apertures.

10. The lid of claim 8, wherein the flange extends around the entire periphery of the main body.

11. The lid of claim 8, wherein the plurality of apertures is a first plurality, the flange further including a second plurality of elongated apertures therethrough disposed at an opposite side of the main body from the first plurality of apertures.

12. The lid of claim 8, wherein each of the apertures is oval in shape.

13. A cookware lid comprising:
a main body having a peripheral rim, and
pads formed of thermally insulating material disposed on the main body adjacent to the peripheral rim.

14. The lid of claim 13, wherein the pads are disposed at an upper surface of the main body.

15. The lid of claim 14, wherein the main body defines recesses in which the pads are respectively disposed.

16. The lid of claim 13, wherein the main body is circular in shape, the pads being disposed respectively at diametrically opposed locations on the main body.

17. The lid of claim 13, wherein each of the pads is substantially thicker than the rest of the main body.

18. Cookware comprising:
an open-top vessel having an upstanding peripheral wall terminating at an upper edge, and
a pour spout formed on the peripheral wall at the upper edge; and
a lid having a main body,
a flange depending from the main body,
the flange having a plurality of vertically elongated apertures therethrough grouped adjacent to a predetermined location on the main body, and
indicia on the main body at the predetermined location for indicating the location of the apertures,
the lid being disposable on the upper edge of the vessel in a covering condition for closing the open top at the vessel with the flange disposed within the upper edge of the peripheral wall,
the lid while in the covering condition being disposable in a first orientation with the apertures out of alignment with the pour spout and in a second orientation with the apertures aligned with the pour spout.

19. The cookware of claim 18, wherein the vessel includes handles respectively extending laterally outwardly from the peripheral wall at opposite sides of the vessel.

20. The cookware of claim 19, wherein the pour spout is a first spout, the vessel further including a second pour spout disposed at a diametrically opposed location from the first pour spout, the spouts being disposed along a diameter which extends substantially perpendicular to a diameter along which the handles are disposed.

21. The cookware of claim 20, wherein the lid includes pads formed of thermally insulating material disposed on the main body at diametrically opposed locations, the predetermined location of the indicia being angularly spaced approximately 90° from each of the pads.

22. The cookware of claim 18, wherein the main body of the lid includes an outer peripheral frame defining a central opening, a central member discrete from the frame and disposed in the central opening, and support structure coupled to each of the frame and the central member for cooperation therewith to seal the central opening.

23. The cookware of claim 22, wherein the central member of the lid is formed of glass.

24. The cookware of claim 22, wherein the support structure is annular in shape and substantially channel-shaped in transverse cross section.
